(19) United States
(12) Patent Application Publication
(10) Pub. No.: US 2026/0245286 A1
(43) Pub. Date: Aug. 20, 2026

(54) TEXTURE GENERATION METHOD AND APPARATUS FOR THREE-DIMENSIONAL MODEL, AND GENERATION METHOD AND APPARATUS FOR THREE-DIMENSIONAL MODEL

(71) Applicant: Beijing Zitiao Network Technology Co., Ltd., Beijing (CN)

(72) Inventor: Guangwei WANG, Beijing (CN)

(21) Appl. No.: 19/161,955

(22) PCT Filed: Jun. 6, 2024
(86) PCT No.: PCT/CN2024/097864

§ 371 Date: Sep. 3, 2025

(30) Foreign Application Priority Data
Jul. 31, 2023 (CN) 202310952854.9

(51) Int. Cl. G06T 15/04

(52) U.S. Cl. CPC G06T 15/04

(57) ABSTRACT

Embodiments of the present disclosure relate to a texture generation method and apparatus for a three-dimensional model, and a generation method and apparatus for a three-dimensional model. The texture generation method for a three-dimensional model includes: obtaining three-dimensional model representation data for a texture to be generated; generating a plurality of local surface maps of a target three-dimensional model based on the three-dimensional model representation data; obtaining a feature corresponding to the local surface map to generate, based on the feature, a texture map corresponding to the local surface map; and obtaining a surface texture of the three-dimensional model based on the texture maps respectively corresponding to the plurality of local surface maps.

### CROSS-REFERENCE TO RELATED APPLICATION(S)

This application claims priority to Chinese Patent Application No. 202310952854.9, filed with the China National Intellectual Property Administration on Jul. 31, 2023 and entitled “TEXTURE GENERATION METHOD AND APPARATUS FOR THREE-DIMENSIONAL MODEL, AND GENERATION METHOD AND APPARATUS FOR THREE-DIMENSIONAL MODEL”, which is incorporated herein by reference in its entirety.

### FIELD

The present disclosure relates to the field of computer technologies, and in particular, to a texture generation method and apparatus for a three-dimensional model, and a generation method and apparatus for a three-dimensional model.

### BACKGROUND

Three-dimensional models are usually used in virtual scenarios such as virtual reality (VR), and presentation effects of the three-dimensional models are critical.

### SUMMARY

The present disclosure provides a texture generation method and apparatus for a three-dimensional model, and a generation method and apparatus for a three-dimensional model.

According to a first aspect, embodiments of the present disclosure provide a texture generation method for a three-dimensional model. The method includes: obtaining three-dimensional model representation data for a texture to be generated; generating a plurality of local surface regions of a target three-dimensional model based on the three-dimensional model representation data; obtaining a feature corresponding to the local surface region to generate, based on the feature, a texture map corresponding to the local surface region; and obtaining a surface texture of the target three-dimensional model based on the texture maps respectively corresponding to the plurality of local surface regions.

According to a second aspect, embodiments of the present disclosure provide a generation method for a three-dimensional model. The method includes: generating three-dimensional model representation data for a texture to be generated based on received model information; obtaining a surface texture corresponding to the three-dimensional model representation data, where the surface texture is obtained by using the texture generation method for a three-dimensional model by using the texture generation method for a three-dimensional model according to the first aspect; and generating a target three-dimensional model based on the three-dimensional model representation data and the surface texture corresponding to the three-dimensional model representation data.

According to a third aspect, embodiments of the present disclosure provide a texture generation apparatus for a three-dimensional model. The apparatus includes: a model data obtaining module configured to obtain three-dimensional model representation data for a texture to be generated; a local region generation module configured to generate a plurality of local surface regions of a target three-dimensional model based on the three-dimensional model representation data; a texture map generation module configured to obtain a feature corresponding to the local surface region to generate, based on the feature, a texture map corresponding to the local surface region; and a surface texture generation module configured to obtain a surface texture of the target three-dimensional model based on the texture maps respectively corresponding to the plurality of local surface regions.

According to a fourth aspect, embodiments of the present disclosure further provide a generation apparatus for a three-dimensional model. The apparatus includes: a model data generation module configured to generate three-dimensional model representation data for a texture to be generated based on received model information; a surface texture obtaining module configured to obtain a surface texture corresponding to the three-dimensional model representation data, where the surface texture is obtained by using the texture generation method for a three-dimensional model by using the texture generation method for a three-dimensional model according to the first aspect; and a target model generation module configured to generate a target three-dimensional model based on the three-dimensional model representation data and the surface texture corresponding to the three-dimensional model representation data.

According to a fifth aspect, embodiments of the present disclosure further provide an electronic device. The electronic device includes: a processor; and a memory configured to store instructions executable by the processor, where the processor is configured to read the executable instructions from the memory, and execute the instructions to implement the texture generation method for a three-dimensional model or the generation method for a three-dimensional model provided in the embodiments of the present disclosure.

According to a sixth aspect, embodiments of the present disclosure further provide a computer-readable storage medium having a computer program stored thereon, where the computer program is configured to perform the texture generation method for a three-dimensional model or the generation method for a three-dimensional model provided in the embodiments of the present disclosure.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic diagram of a model texture according to embodiments of the present disclosure;

FIG. 2 is a schematic flowchart of a texture generation method for a three-dimensional model according to embodiments of the present disclosure;

FIG. 3 is a schematic flowchart of a generation method for a three-dimensional model according to embodiments of the present disclosure;

FIG. 4 is a schematic structural diagram of a generative network for a three-dimensional model according to embodiments of the present disclosure;

FIG. 5 is a schematic structural diagram of a generative network for a three-dimensional model according to embodiments of the present disclosure;

FIG. 6 is a schematic structural diagram of a texture generation apparatus for a three-dimensional model according to embodiments of the present disclosure;

FIG. 7 is a schematic structural diagram of a generation apparatus for a three-dimensional model according to embodiments of the present disclosure; and

FIG. 8 is a schematic structural diagram of an electronic device according to embodiments of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

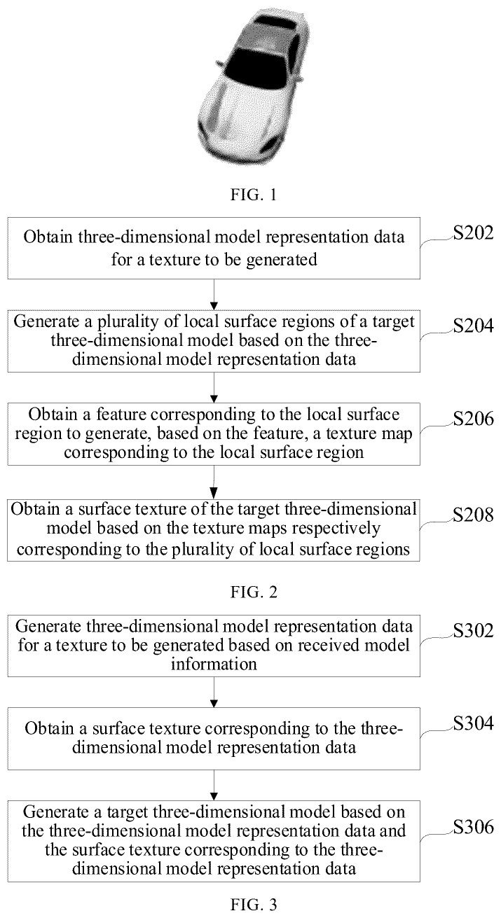

The inventors have found through research that a texture generation manner used in the process of generating a three-dimensional model is poor in the related art. Specifically, in the related art, each point on a surface of the three-dimensional model needs to be processed separately to determine a color corresponding to the point, thereby finally obtaining a surface texture of the three-dimensional model. However, an effect of the texture obtained in this manner is poor and a problem such as color layering is prone to occur. For example, referring to a schematic diagram of a model texture shown in FIG. 1, a texture of a vehicle in FIG. 1 is clearly layered, uneven, and the like. As a result, the surface texture of the three-dimensional model that is generated by using the related art is poor in color rationality and local continuity. In order to improve at least one of the above problems, embodiments of the present disclosure provide a texture generation method and apparatus for a three-dimensional model, and a generation method and apparatus for a three-dimensional model, which are described in detail below.

In the texture generation method for a three-dimensional model provided in the embodiments of the present disclosure, a plurality of local surface regions can be generated based on three-dimensional model representation data for a texture to be generated, a feature corresponding to the local surface region is obtained to generate, based on the feature, a texture map corresponding to the local surface region, and a surface texture of a three-dimensional model is finally obtained based on the texture maps respectively corresponding to the plurality of local surface maps. The above manner of generating the corresponding texture maps directly using the features of the plurality of local surface regions of the three-dimensional model is more efficient, and can also better guarantee local continuity of the surface texture of the three-dimensional model and effectively guarantee a texture generation effect of the three-dimensional model. Further, in the generation method for a three-dimensional model provided in the embodiments of the present disclosure, three-dimensional model representation data for a texture to be generated is first generated, and a surface texture with a better effect is generated by using the aforementioned texture generation method for a three-dimensional model, to guarantee a presentation effect of the target three-dimensional model that is finally obtained, and can better guarantee user viewing experience.

FIG. 2 is a schematic flowchart of a texture generation method for a three-dimensional model according to embodiments of the present disclosure. The method may be performed by a texture generation apparatus for a three-dimensional model. The apparatus may be implemented by software and/or hardware and may be generally integrated into an electronic device. As shown in FIG. 2, the method mainly includes the following steps S202 to S208.

Step S202: three-dimensional model representation data for a texture to be generated is obtained.

The three-dimensional model representation data may be implicit representation data of a three-dimensional model, explicit representation data of a three-dimensional model, or hybrid implicit-explicit representation data of a three-dimensional model. The explicit representation data can intuitively present geometry of the model, and may also be understood as representing the three-dimensional model through an explicit 3D structure. For example, for a spatial point, it can be clearly and intuitively known whether the spatial point is located inside or outside the model. The implicit representation data only includes structural information of the model, and may also be understood as representing the three-dimensional model through an implicit 3D structure. As a result, the geometry of the model cannot be intuitively presented, and it is necessary to predict whether the spatial point is located inside or outside the model by using a network. The hybrid implicit-explicit representation data may combine advantages of the explicit representation data and the implicit representation data. For example, the data may be presented based on three orthogonal feature planes, which may be referred to as tri-plane data. Compared with the explicit representation data, the hybrid implicit-explicit representation data requires a smaller amount of data, thereby effectively reducing an amount of operations. Compared with the implicit representation data, the hybrid implicit-explicit representation data can explicitly represent the three-dimensional model to some extent, and help to determine a model structure more accurately. In actual application, a type of the three-dimensional model representation data may be flexibly selected, which is not limited herein.

In actual application, it is possible to first generate untextured three-dimensional model representation data based on model information, or directly obtain existing untextured three-dimensional model representation data, which is not limited herein. In addition, the embodiments of the present disclosure do not limit a model type corresponding to the three-dimensional model representation data. For example, the model type may include an article, an animal, a person, a building, or the like.

Step S204: a plurality of local surface regions of a target three-dimensional model are generated based on the three-dimensional model representation data.

In actual application, it is possible to determine the target three-dimensional model based on the three-dimensional model representation data and divide a surface of the target three-dimensional model into a plurality of patches, thereby obtaining the plurality of local surface regions. In some implementation examples, the local surface region may be represented by a set of points or may be represented directly in the form of an image, that is, the local surface region may be in the form of a local surface map.

In some implementation examples, a combination of the plurality of local surface regions covers a full surface of the target three-dimensional model, thereby ensuring that an entire surface texture of the target three-dimensional model can be obtained completely. In addition, part of the plurality of local surface regions may also have overlapping regions, which is not limited herein.

In actual application, shapes and sizes of different local surface regions may be the same, e.g., a rectangle or a triangle with a specified size, or the like. Alternatively, local surface regions with different shapes and/or sizes may exist among the plurality of local surface regions. Since the three-dimensional model is of a three-dimensional structure, the surface may not be regular in many cases. Therefore, local surface regions with different shapes or local surface regions that are the same in shape but different in size may be generated according to actual situations. This manner is more flexible.

Step S206: a feature corresponding to the local surface region to generate is obtained, based on the feature, a texture map corresponding to the local surface region.

In actual application, the embodiments of the present disclosure do not limit a manner of obtaining the feature of the local surface region, and a manner of generating the corresponding texture map based on the feature corresponding to the local surface region is efficient, and also takes into account information of a plurality of points in the local surface region when the texture map is generated. Compared with a manner in the related art of separately generating a corresponding texture color directly for each point, the above manner provided in these embodiments of the present disclosure also takes into account information of peripheral points when determining texture information of a point, due to processing the entire local surface region, so that rationality of a color of each point and local continuity of the surface texture of the model can be effectively guaranteed, and the obtained texture map is more reliable.

For example, the texture maps respectively corresponding to the plurality of local surface regions may be determined by using a preset neural network based on the features corresponding to the plurality of local surface regions. In some specific examples, a neural network may be used to convert a feature map into an RGB image to obtain, based on the RGB image, a texture map corresponding to the local surface region. For example, the RGB image may be directly used as the texture map; or the RGB image may be fine-tuned according to requirements, and a fine-tuned RGB image is used as the texture map. In addition, the embodiments of the present disclosure do not limit the neural network. For example, the neural network may be a Unet network, or any other network capable of converting the feature map into a three-channel RGB image.

Step S208: a surface texture of the target three-dimensional model is obtained based on the texture maps respectively corresponding to the plurality of local surface regions. Specifically, the texture maps respectively corresponding to the plurality of local surface regions are combined based on positions of the corresponding surface local regions on the three-dimensional model, thereby obtaining the entire surface texture of the three-dimensional model.

The above manner of generating the corresponding texture maps directly using the feature maps of the plurality of local surface regions of the three-dimensional model requires a smaller amount of operations, is more efficient, and can also better guarantee local continuity of the surface texture of the three-dimensional model and effectively guarantee a texture generation effect of the three-dimensional model.

The embodiments of the present disclosure provide an implementation example for obtaining the feature corresponding to the local surface region, which may be performed with reference to step A and step B as follows.

Step A: a plurality of sub-units in the local surface region are determined, and a unit feature of the sub-unit is obtained.

The sub-units of the local surface region may be flexibly set according to actual requirements. For example, each point in the local surface region may be considered as one sub-unit. For another example, a plurality of point clusters in the local surface region may be considered as one sub-unit. For another example, each unit region obtained through division in a preset manner in the local surface region may be considered as one sub-unit, and a size of the unit region may be flexibly set according to requirements.

In some specific implementation examples, the three-dimensional model representation data is implemented based on three orthogonal feature planes, and the three feature planes are perpendicular to each other, which may also be referred to as a tri-plane. For example, each feature plane is 256*256*32. In actual application, when obtaining the unit feature of the sub-unit, the sub-unit may be first projected onto each of the feature planes separately. Then, the unit feature of the sub-unit is determined based on a projection result of the sub-unit on each of the feature planes. It can be understood that, as described above, since the three-dimensional model representation data implemented using the three orthogonal feature planes combines an explicit advantage and an implicit advantage, the manner of directly projecting the sub-unit on each of the feature planes to determine the corresponding unit feature requires a smaller amount of operations on the basis that a feature extraction effect can be effectively guaranteed, and can more efficiently obtain the unit feature of the sub-unit.

Step B: the feature corresponding to the local surface region is determined based on unit features of the plurality of sub-units.

For example, a set of the unit features of the sub-units on the local surface region may be directly used as the feature corresponding to the local surface region. Alternatively, the unit features of the sub-units on the local surface region may be combined and concatenated to obtain the feature corresponding to the local surface region, and the feature may also be represented in the form of a feature map. In this way, the corresponding feature may be extracted separately for each local surface region, and the feature corresponding to each local surface region can be further input into the neural network to obtain the texture map corresponding to each local surface region.

The above manner is mainly to determine the surface texture of the model based on textures of the plurality of local surface regions on the model, and can improve texture generation efficiency compared with the manner, in the related art, of directly determining the texture color of each point on the model. In addition, the manner of directly determining the corresponding feature based on the local surface region to determine the corresponding texture map can take into account information of a plurality of points in the local region in a comprehensive manner, and the feature information of the plurality of points in the local region can affect each other. Therefore, color rationality of the model surface and local continuity of the surface texture of the model can be effectively guaranteed, problems such as color layering and discontinuity in the related art can be avoided, and the texture map that is finally obtained is more reliable.

On the basis of the foregoing, the embodiments of the present disclosure further provide a generation method for a three-dimensional model. FIG. 3 is a schematic flowchart of a generation method for a three-dimensional model according to embodiments of the present disclosure. The method may be performed by a generation apparatus for a three-dimensional model. The apparatus may be implemented by software and/or hardware and may be generally integrated into an electronic device. As shown in FIG. 3, the method mainly includes the following steps S302 to S306.

Step S302: three-dimensional model representation data for a texture to be generated is generated based on received model information.

In actual application, the model information may be noise including model information, a model description text, a two-dimensional image corresponding to a model, or the like. The embodiments of the present disclosure do not limit a representation form of the model information. In addition, the embodiments of the present disclosure do not limit a specific implementation of generating the three-dimensional model representation data for the texture to be generated based on the model information. The three-dimensional model representation data may be represented using the implicit representation data, the explicit representation data, or the hybrid implicit-explicit representation data of the three-dimensional model described above, which is not limited herein.

In some implementation examples, the three-dimensional model representation data corresponding to the model information is implemented based on three orthogonal feature planes. In this way, generation efficiency of the three-dimensional model representation data is higher, a smaller amount of operations is required, and reliability of a model structure can be better guaranteed to some extent. In some specific implementation examples, the three-dimensional model representation data may be directly represented by using the three orthogonal feature planes. In some other specific implementation examples, the three-dimensional model representation data may be model geometry data that is finally obtained by using the three orthogonal feature planes and that can intuitively present a three-dimensional structure of the model. For example, the model geometry data may be a 3D mesh model.

In some specific implementation examples, a preset 3D generative adversarial network (GAN) may be used to generate the three-dimensional model representation data for the texture to be generated based on the received model information, and accurate and realistic three-dimensional model representation data is generated with the aid of a powerful expression capability of the GAN network.

Step S304: a surface texture corresponding to the three-dimensional model representation data is obtained, where the surface texture is obtained by using the aforementioned texture generation method for a three-dimensional model. For details, reference may be made to the related content described above. Details are not described herein again.

In some specific implementation examples, a preset 2D GAN network may be used to obtain a surface texture of an initial three-dimensional model. That is, the model texture is generated in 2D space. Compared with a manner of generating a model texture directly in 3D space in the related art, a smaller amount of operations is required, and local continuity is better guaranteed in the manner of obtaining the model texture based on a local surface region in the 2D space.

Step S306: a target three-dimensional model is generated based on the three-dimensional model representation data and the surface texture corresponding to the three-dimensional model representation data.

The above-mentioned generation method for a three-dimensional model provided in these embodiments of the present disclosure can generate the surface texture with a better effect by using the texture generation method for a three-dimensional model, to guarantee a presentation effect of the target three-dimensional model that is finally obtained, and can better guarantee user viewing experience.

In some implementation examples, the step of generating three-dimensional model representation data for a texture to be generated based on received model information includes: generating the three-dimensional model representation data for the texture to be generated by using a preset generative network based on the received model information. The embodiments of the present disclosure do not limit a specific structure of the generative network, and any manner capable of generating the three-dimensional model representation data may be used. For example, the generative network is obtained through training based on the following steps a to c.

Step a: a model information sample and a base image at a target viewing angle that corresponds to three-dimensional model representation data of the model information sample are obtained, where the base image includes one or more of a depth map, a normal map, and a mask map. In actual application, a model three-dimensional structure may be determined based on the three-dimensional model representation data corresponding to the model information sample. It can be understood that the model three-dimensional structure at different viewing angles corresponds to different base images. In actual application, it is possible to flexibly set the target viewing angle and obtain the base image of the model three-dimensional structure at the target viewing angle as the base image at the target viewing angle that corresponds to the three-dimensional model representation data.

Step b: three-dimensional model representation data for a texture to be generated that is output by a preset initial network for the model information sample is obtained, and a base image at the target viewing angle that corresponds to the three-dimensional model representation data output by the initial network is obtained.

In some implementation examples, the three-dimensional model representation data is implemented based on the three orthogonal feature planes. In this case, the base image at the target viewing angle that corresponds to the three-dimensional model representation data output by the initial network may be obtained by using a neural rendering algorithm based on the three orthogonal feature planes. A smaller amount of operations is required, and the base image can be generated more efficiently.

Step c: a parameter of the initial network is adjusted based on a difference between the base image corresponding to the three-dimensional model sample and the base image corresponding to the initial network, to obtain the generative network.

It can be understood that if a difference between the three-dimensional model representation data of the model information sample and the three-dimensional model representation data output by the initial network is directly compared, a large amount of data is required, and a significant amount of computational resources needs to be consumed. The embodiments of the present disclosure compare the base images (one or more of the depth map, the normal map, and the mask map) corresponding to the two types of three-dimensional model representation data, so that only a small amount of operations is required. Moreover, since the base image corresponds to the three-dimensional model representation data, comparing the difference between the base images is equivalent to indirectly comparing the difference between the two types of three-dimensional model representation data, so that a better network training effect can be achieved. Moreover, the parameters of the initial network are adjusted with the objective of reducing the difference between the base images, the difference between the two types of three-dimensional model representation data is also reduced accordingly, so that the initial network can gradually output the three-dimensional model representation data that approximates the three-dimensional model representation data of the model information sample, and the trained generative network is finally obtained.

For ease of understanding, in some specific implementation examples, a generation process of the three-dimensional model may be divided into two stages. A first stage is used to generate an untextured initial three-dimensional model, where the initial three-dimensional model may be a three-dimensional model obtained based on the aforementioned three-dimensional model representation data. For example, the initial three-dimensional model may be a 3D mesh model. A second stage is used to generate a surface texture of the initial three-dimensional model, thereby finally obtaining the required target three-dimensional model.

For ease of understanding, on the basis of the foregoing, reference may be first made to the schematic structural diagram of a generative network for a three-dimensional model shown in FIG. 4, which illustrates that the generative network for a three-dimensional model includes a first-stage network and a second-stage network. For example, the first-stage network includes a 3D GAN network, and the second-stage network includes a 2D GAN network. The first-stage network is used to generate an untextured initial three-dimensional model based on received model information, and the second-stage network is used to generate a surface texture of the initial three-dimensional model based on output of the first-stage network, thereby obtaining a target three-dimensional model. In a specific implementation, the second-stage network may generate a series of local surface maps (corresponding to the aforementioned local surface regions, which may be referred to as patches) based on a model structure output by the first-stage network, and then obtain texture maps corresponding to the local surface maps.

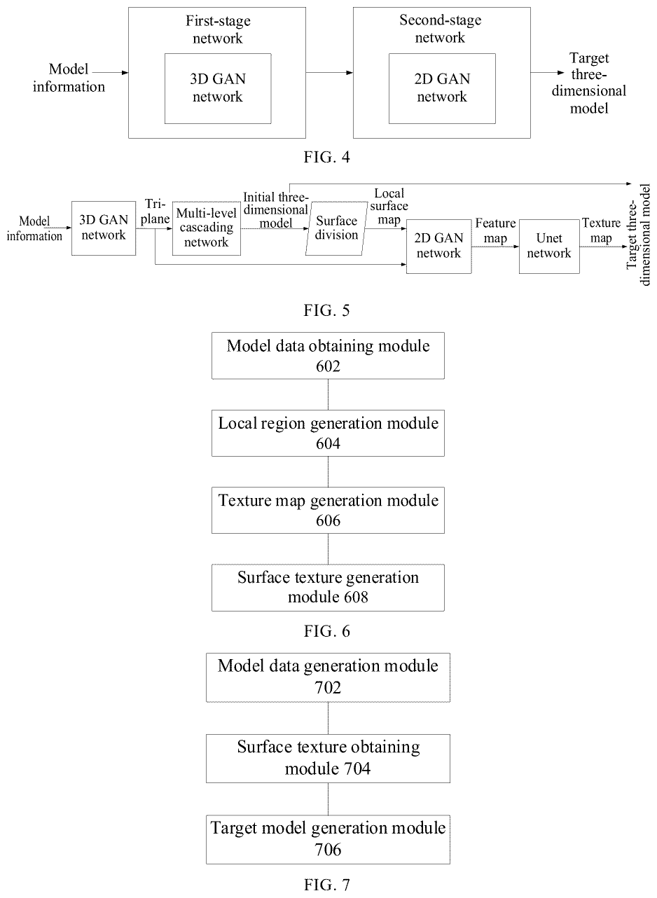

On the foregoing basis, the embodiments of the present disclosure further provide a schematic structural diagram of a generative network for a three-dimensional model shown in FIG. 5. Specifically, the model information is input into the 3D GAN network to obtain a tri-plane (i.e., three orthogonal feature planes, which may be referred to as a tri-plane). An initial three-dimensional model may be obtained after spatial points in the tri-plane pass through a multi-level cascading network, where the initial three-dimensional model may be obtained based on the tri-plane. A plurality of local surface maps (patches) may be obtained by dividing a surface of the initial three-dimensional model, feature maps (feature patches) corresponding to the local surface maps may be obtained by using the 2D GAN network based on the tri-plane, texture maps corresponding to the local surface maps may be obtained by using a Unet network based on the feature maps corresponding to the local surface maps, and the target three-dimensional model may be obtained based on the initial three-dimensional model and the texture maps. The 3D GAN network and the multi-level cascading network may both be considered as the first-stage networks, and the 2D GAN network and the Unet network may both be considered as the second-stage networks. FIG. 5 is only an example for description, and another network structure may be used in actual application, which is not limited herein.

For ease of understanding, the embodiments of the present disclosure further provide a manner of training the generative network for a three-dimensional model. Specifically, a to-be-trained generative network for a three-dimensional model can generate an initial three-dimensional model for a texture to be generated and a surface texture of the initial three-dimensional model based on model sample information of a three-dimensional model sample, thereby obtaining a target three-dimensional model corresponding to the model sample information. A first loss is determined based on a difference between a base image (one or more of a depth map, a normal map, and a mask map) corresponding to the initial three-dimensional model and a base image of the three-dimensional model sample, and a second loss is determined based on a difference between a rendered image of the target three-dimensional model and a rendered image of the three-dimensional model sample, where parameters of the generative network for a three-dimensional model are adjusted based on the first loss and the second loss. It can be understood that both the base image and the rendered image are directly related to the model structure. Compared with a manner of adjusting network parameters based on a model structure difference, a manner of adjusting network parameters based on an image difference requires a smaller amount of operations, and is more convenient and fast.

In actual application, in order to improve network training efficiency, a network training process may also be divided into two stages. At a first training stage, parameters of the first-stage network in the generative network for a three-dimensional model are iteratively optimized based mainly on the first loss until the first loss converges within a preset threshold range. In this case, the first-stage network can output an initial network model that meets an expectation, and then the parameters of the first-stage network are fixed. Further, parameters of the second-stage network in the generative network for a three-dimensional model are iteratively optimized based on the second loss until the second loss converges within the preset threshold range. In this way, the generative network for a three-dimensional model can be obtained more efficiently and reliably. In addition, the embodiments of the present disclosure do not limit the first loss and the second loss. For example, the first loss and the second loss may be GAN losses.

In summary, according to the generation method for a three-dimensional model provided in the embodiments of the present disclosure, the reliable initial network model can be generated at the first stage by using the generative network for a three-dimensional model. The surface texture with the better effect is generated at the second stage, to guarantee the presentation effect of the target three-dimensional model finally obtained, and can better guarantee user viewing experience.

Corresponding to the aforementioned texture generation method for a three-dimensional model, FIG. 6 is a schematic structural diagram of a texture generation apparatus for a three-dimensional model according to embodiments of the present disclosure. The apparatus may be implemented by software and/or hardware, and may be generally integrated in an electronic device. As shown in FIG. 6, the apparatus includes:
a model data obtaining module 602 configured to obtain three-dimensional model representation data for a texture to be generated;
a local region generation module 604 configured to generate a plurality of local surface regions of a target three-dimensional model based on the three-dimensional model representation data;
a texture map generation module 606 configured to obtain a feature corresponding to the local surface region to generate, based on the feature, a texture map corresponding to the local surface region; and
a surface texture generation module 608 configured to obtain a surface texture of the target three-dimensional model based on the texture maps respectively corresponding to the plurality of local surface regions.

The above-mentioned apparatus for generating the corresponding texture maps directly using the features of the plurality of local surface regions of the three-dimensional model can better guarantee local continuity of the surface texture of the three-dimensional model and effectively guarantee a texture generation effect of the three-dimensional model.

In some implementations, the texture map generation module 606 is specifically configured to: determine a plurality of sub-units in the local surface region, and obtain a unit feature of the sub-unit; and determine the feature corresponding to the local surface region based on the unit features of the plurality of sub-units.

In some implementations, the three-dimensional model representation data is implemented based on three orthogonal feature planes, and the texture map generation module 606 is specifically configured to: project the sub-unit on each of the feature planes separately; and determine the unit feature of the sub-unit based on a projection result of the sub-unit on each of the feature planes.

In some implementations, the texture map generation module 606 is specifically configured to: determine the texture maps respectively corresponding to the plurality of local surface regions by using a preset neural network based on the features corresponding to the plurality of local surface regions.

In some implementations, a combination of the plurality of local surface regions covers a full surface of the three-dimensional model.

In some implementations, shapes and sizes of different local surface regions are the same; or local surface regions with different shapes and/or sizes exist among the plurality of local surface regions.

The texture generation apparatus for a three-dimensional model provided in these embodiments of the present disclosure can perform the texture generation method for a three-dimensional model provided in any embodiments of the present disclosure, and has corresponding functional modules and beneficial effects for performing the method.

It can be clearly understood by those skilled in the art that, for convenience and brevity of description, for the specific operation processes of the apparatus embodiment described above, reference may be made to the corresponding processes in the foregoing method embodiments, and details are not described herein again.

Corresponding to the aforementioned generation method for a three-dimensional model, FIG. 7 is a schematic structural diagram of a generation apparatus for a three-dimensional model according to embodiments of the present disclosure. The apparatus may be implemented by software and/or hardware, and may be generally integrated in an electronic device. As shown in FIG. 7, the apparatus includes:
a model data generation module 702 configured to generate three-dimensional model representation data for a texture to be generated based on received model information;
a surface texture obtaining module 704 configured to obtain a surface texture corresponding to the three-dimensional model representation data, where the surface texture is obtained by using any of the aforementioned texture generation methods for a three-dimensional model; and
a target model generation module 706 configured to generate a target three-dimensional model based on the three-dimensional model representation data and the surface texture corresponding to the three-dimensional model representation data.

The above-mentioned generation apparatus for a three-dimensional model provided in these embodiments of the present disclosure can generate the surface texture with a better effect by using the aforementioned texture generation method for a three-dimensional model, to guarantee a presentation effect of the target three-dimensional model finally obtained, and can better guarantee user viewing experience.

In some implementations, the three-dimensional model representation data corresponding to the model information is implemented based on three orthogonal feature planes.

In some implementations, the model data generation module 702 is specifically configured to: generate the three-dimensional model representation data for the texture to be generated by using a preset generative network based on the received model information.

In some implementations, the apparatus further includes a training module configured to obtain the generative network through training based on the following steps: obtaining a model information sample and a base image at a target viewing angle that corresponds to three-dimensional model representation data of the model information sample, where the base image includes one or more of a depth map, a normal map, and a mask map; obtaining three-dimensional model representation data for a texture to be generated that is output by a preset initial network for the model information sample, and obtaining a base image at the target viewing angle that corresponds to the three-dimensional model representation data output by the initial network; and adjusting a parameter of the initial network based on a difference between the base image corresponding to the three-dimensional model sample and the base image corresponding to the initial network, to obtain the generative network.

In some implementations, the training module is specifically configured to obtain, by using a neural rendering algorithm based on the three orthogonal feature planes, the base image at the target viewing angle that corresponds to the three-dimensional model representation data output by the initial network.

In some implementations, the model data generation module 702 is specifically configured to: generate the three-dimensional model representation data for the texture to be generated by using a preset 3D GAN network based on the received model information; and In some implementations, the surface texture obtaining module 704 is specifically configured to: obtain, by using a preset 2D GAN network, the surface texture corresponding to the three-dimensional model representation data.

The texture apparatus for a three-dimensional model provided in these embodiments of the present disclosure can perform the texture method for a three-dimensional model provided in any embodiment of the present disclosure, and has corresponding functional modules and beneficial effects for performing the method.

It can be clearly understood by those skilled in the art that, for convenience and brevity of description, for the specific operation processes of the apparatus embodiment described above, reference may be made to the corresponding processes in the foregoing method embodiments, and details are not described herein again.

Embodiments of the present disclosure further provide an electronic device. The electronic device includes: a storage apparatus having a computer program stored thereon; and a processing apparatus configured to execute the computer program in the storage apparatus to implement the steps of the texture generation method for a three-dimensional model or the steps of the generation apparatus for a three-dimensional model.

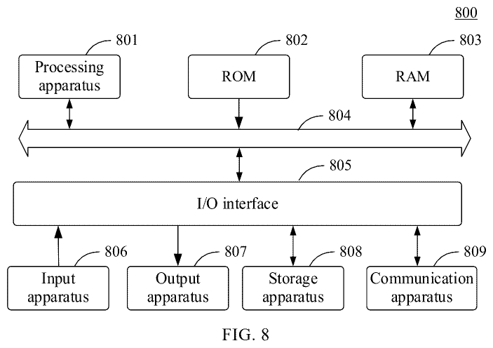

Reference is made to FIG. 8 below, which is a schematic structural diagram of an electronic device 800 suitable for implementing embodiments of the present disclosure. A terminal device in these embodiments of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (for example, a central processing unit or a graphics processing unit) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. More or fewer apparatuses may alternatively be implemented or provided.

In particular, according to embodiments of the present disclosure, the process described above with reference to the flowchart may be implemented as a computer software program. For example, embodiments of the present disclosure include a computer program product, which includes a computer program carried on a non-transitory computer-readable medium, where the computer program includes program code for performing the method shown in the flowchart. In such embodiments, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiments of the present disclosure are performed.

In addition to the above method and device, embodiments of the present disclosure may further be a computer program product including computer program instructions that, when run by a processor, cause the processor to perform the image processing method provided in the embodiments of the present disclosure. In the computer program product, program code for performing the operations of the embodiments of the present disclosure may be written in any combination of one or more programming languages, where the programming languages include an object oriented programming language, such as Java, and C++, and further include conventional procedural programming languages, such as “C” language or similar programming languages. The program code may be completely executed on a user computing device, partially executed on a user device, executed as an independent software package, executed partially on a user computing device and partially on a remote computing device, or completely executed on a remote computing device or a server.

In addition, embodiments of the present disclosure may further be a computer-readable storage medium having computer program instructions stored thereon, where the computer program instructions, when run by a processor, cause the processor to perform the method provided in the embodiments of the present disclosure.

The computer-readable storage medium may be any combination of one or more readable media. The readable medium may be a readable signal medium or a readable storage medium. The readable storage medium may include, for example, but not limited to, an electronic, magnetic, optical, electromagnetic, infrared, or semiconductor system, apparatus, or device, or any combination thereof. More specific examples of the readable storage media (a non-exhaustive list) include: an electrical connection having one or more wires, a portable disk, a hard disk, a random-access memory (RAM), a read-only memory (ROM), an erasable programmable read-only memory (EPROM or flash), an optic fiber, a portable compact disk read-only memory (CD-ROM), an optical storage device, a magnetic storage device, or any suitable combination thereof.

Embodiments of the present disclosure further provide a computer program product, including a computer program/instructions that, when executed by a processor, implement the method in the embodiments of the present disclosure.

It can be understood that before the use of the technical solutions disclosed in the embodiments of the present disclosure, the user shall be informed of the type, range of use, use scenarios, etc. of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A texture generation method for a three-dimensional model, comprising:
obtaining three-dimensional model representation data for a texture to be generated;
generating a plurality of local surface regions of a target three-dimensional model based on the three-dimensional model representation data;
obtaining a feature corresponding to the local surface region to generate, based on the feature, a texture map corresponding to the local surface region; and
obtaining a surface texture of the target three-dimensional model based on the texture maps respectively corresponding to the plurality of local surface regions.

2. The method according to claim 1, wherein obtaining the feature corresponding to the local surface region comprises:
determining a plurality of sub-units in the local surface region, and obtaining a unit feature of the sub-unit; and
determining the feature corresponding to the local surface region based on the unit features of the plurality of sub-units.

3. The method according to claim 2, wherein the three-dimensional model representation data is implemented based on three orthogonal feature planes, and obtaining the unit feature of the sub-unit comprises:
projecting the sub-unit on each of the feature planes separately; and determining the unit feature of the sub-unit based on a projection result of the sub-unit on each of the feature planes.

4. The method according to claim 1, wherein generating, based on the feature map, the texture map corresponding to the local surface region comprises:
determining the texture maps respectively corresponding to the plurality of local surface regions by using a preset neural network based on the features corresponding to the plurality of local surface regions.

5. The method according to claim 1, wherein a combination of the plurality of local surface regions covers a full surface of the three-dimensional model.

6. The method according to claim 1, wherein shapes and sizes of different local surface regions are the same; or local surface regions with different shapes and/or sizes exist among the plurality of local surface regions.

7. A generation method for a three-dimensional model, comprising:
generating three-dimensional model representation data for a texture to be generated based on received model information;
obtaining a surface texture corresponding to the three-dimensional model representation data, wherein the surface texture is obtained by:
obtaining three-dimensional model representation data for a texture to be generated;
generating a plurality of local surface regions of a target three-dimensional model based on the three-dimensional model representation data;
obtaining a feature corresponding to the local surface region to generate, based on the feature, a texture map corresponding to the local surface region; and
obtaining a surface texture of the target three-dimensional model based on the texture maps respectively corresponding to the plurality of local surface regions; and
generating a target three-dimensional model based on the three-dimensional model representation data and the surface texture corresponding to the three-dimensional model representation data.

8. The method according to claim 7, wherein the three-dimensional model representation data corresponding to the model information is implemented based on three orthogonal feature planes.

9. The method according to claim 8, wherein generating the three-dimensional model representation data for the texture to be generated based on the received model information comprises:
generating the three-dimensional model representation data for the texture to be generated by using a preset generative network based on the received model information.

10. The method according to claim 9, wherein the generative network is obtained through training based on the following steps:
obtaining a model information sample and a base image at a target viewing angle that corresponds to three-dimensional model representation data of the model information sample, the base image comprising one or more of a depth map, a normal map, and a mask map;
obtaining three-dimensional model representation data for a texture to be generated that is output by a preset initial network for the model information sample, and obtaining a base image at the target viewing angle that corresponds to the three-dimensional model representation data output by the initial network; and
adjusting a parameter of the initial network based on a difference between the base image corresponding to the three-dimensional model sample and the base image corresponding to the initial network, to obtain the generative network.

11. The method according to claim 10, wherein obtaining the base image at the target viewing angle that corresponds to the three-dimensional model representation data output by the initial network comprises:
obtaining, by using a neural rendering algorithm based on the three orthogonal feature planes, the base image at the target viewing angle that corresponds to the three-dimensional model representation data output by the initial network.

12. The method according to claim 7, wherein generating the three-dimensional model representation data for the texture to be generated based on the received model information comprises:
generating the three-dimensional model representation data for the texture to be generated by using a preset 3D GAN network based on the received model information; and
obtaining the surface texture corresponding to the three-dimensional model representation data comprises:
obtaining, by using a preset 2D GAN network, the surface texture corresponding to the three-dimensional model representation data.

13. (canceled)

14. (canceled)

15. An electronic device, comprising:
a storage apparatus having a computer program stored thereon; and
a processing apparatus, wherein the computer program, when executed by the processing apparatus, causes the electronic device to:
obtain three-dimensional model representation data for a texture to be generated;
generate a plurality of local surface regions of a target three-dimensional model based on the three-dimensional model representation data;
obtain a feature corresponding to the local surface region to generate, based on the feature, a texture map corresponding to the local surface region; and
obtain a surface texture of the target three-dimensional model based on the texture maps respectively corresponding to the plurality of local surface regions.

16. (canceled)

17. The electronic device according to claim 15, wherein the computer program causing the electronic device to obtain the feature corresponding to the local surface region further causes the electronic device to:
determine a plurality of sub-units in the local surface region, and obtaining a unit feature of the sub-unit; and
determine the feature corresponding to the local surface region based on the unit features of the plurality of sub-units.

18. The electronic device according to claim 17, wherein the three-dimensional model representation data is implemented based on three orthogonal feature planes, and the computer program causing the electronic device to obtain the unit feature of the sub-unit further causes the electronic device to:
project the sub-unit on each of the feature planes separately; and
determine the unit feature of the sub-unit based on a projection result of the sub-unit on each of the feature planes.

19. The electronic device according to claim 15, wherein the computer program causing the electronic device to generate, based on the feature map, the texture map corresponding to the local surface region further causes the electronic device to:
determine the texture maps respectively corresponding to the plurality of local surface regions by using a preset neural network based on the features corresponding to the plurality of local surface regions.

20. The electronic device according to claim 15, wherein a combination of the plurality of local surface regions covers a full surface of the three-dimensional model.

21. The electronic device according to claim 15, wherein shapes and sizes of different local surface regions are the same.

22. The electronic device according to claim 15, wherein local surface regions with different shapes and/or sizes exist among the plurality of local surface regions.

23. The electronic device according to claim 15, wherein the three-dimensional model representation data and the surface texture are used to generate the target three-dimensional model.
